(19) United States
(12) Patent Application Publication
(10) Pub. No.: US 2011/0110312 A1
(43) Pub. Date: May 12, 2011

(54) METHOD FOR SCHEDULING RESOURCE, NETWORK ELEMENT AND USER EQUIPMENT

(76) Inventors: Yan Zhao, Shanghai (CN); Tao Yang, Shanghai (CN); Jin Liu, Shanghai (CN)

(21) Appl. No.: 12/674,713

(22) PCT Filed: Aug. 24, 2007
(86) PCT No.: PCT/CN07/02566

§ 371 Date: Jan. 14, 2011

(51) Int. Cl. H04W 72/04

(52) U.S. Cl. 370/329

(57) ABSTRACT

The present invention proposes a method for scheduling resource in a packet network and a network element for exchanging signaling with user equipments, wherein user equipments communicate therebetween using the resource allocated by network elements, said communication comprises talk-spurt periods during which data packets are transmitted and silent periods during which silence descriptor packets are transmitted, said method for scheduling resource comprising: said network element allocates resource for said user equipments for communication; both said user equipment and said network element detect the presence of said silence descriptor packet, and said network element determines the optimized number of resource unit(s) to be allocated to said user equipment during the interval for transmitting said data packet, based on the coding rate of said user equipment, the selected modulation coding scheme and the valid transmission times; the network element starts timing and the user equipment stops using the allocated resource if a silence descriptor packet is detected; when the timing finishes or a request for allocating resource is received from the user equipment before the end of said timing, said network element allocates the determined optimized number of resource unit(s) to said user equipment, and said user equipment begins to use said determined optimized number of resource unit(s); said network element determines the end of the interval for transmitting said data packet by detecting the silence descriptor packet; and when both said user equipment and said network element detect a silence descriptor packet, said user equipment stops using said determined optimized number of resource unit(s), while said network element releases said determined optimized number of resource unit(s).

### FIELD OF THE INVENTION

The present invention relates to the field of communication, and more particularly to scheduling resource in a packet network.

### BACKGROUND OF THE INVENTION

In recent years, due to especially higher data rate and support to mobility, broadband wireless access techniques, for example IEEE 802.16e, have drawn much attention, and are competing with the existing mobile communication systems. Therefore, 3 GPP started a project of 3 G long term evolution in 2005, to provide a better support for the increasing requirement of operators and users with evolved access technique (E-UTRA, Evolved-UTRA) and access network (E-UTRAN), in order to achieve the object of keeping UMTS system a superior one in the next 10 years or even longer time.

FIG. 1 shows the architecture of a version R7 LTE network. In such a network, the IP transmission is adopted between eNodeBs (Evolved Universal Terrestrial Radio Access Network NodeB) at lower layer, and the eNodeBs are interconnected logically via X2 interfaces, thus forming a meshed network. Such a network architecture plan is mainly used for supporting the mobility of user equipments (UE) within the entire network, and ensuring the seamless handover of users. Each eNodeB is connected to access gateway(s) (aGW) by means of a certain form of meshed connection or partly meshed connection. A eNodeB may be connected to a plurality of aGWs, and vice versa. The LTE network employs the techniques of OFDM, MIMO, HARQ, AMC etc. at physical layer.

In such a LTE system, there only exists packet domain, and the voice traffic is carried via VoIP. The voice traffic is the main traffic in current mobile communication systems, and tends towards being carried via IP. VoIP traffic has certain characteristics, such as smaller packet (generally with tens of bytes), substantially fixed packet size and arrival interval of packet. For example voice packet is generated periodically per 20 ms during talk-spurt period and SID (silence descriptor) packet is generated periodically per 160 ms during silent period.

In the downlink, OFDM may meet the requirements of data rate of 100 Mbit/s and spectrum efficiency, and may implement a flexible bandwidth configuration from 1.25 to 20 MHz. LTE follows the concept of HSDPA/HSUPA, i.e. obtaining a gain only by link adaptation and quick retransmission. The downlink modulation schemes of LTE include QPSK, 16 QAM and 64 QAM etc..

In uplink, SC-FDMA is employed, i.e. a base station allocates a single frequency to a UE for transmitting user's data per TTI (transmission time interval), and the data of different users is separated in frequency and time, so as to ensure the orthogonality among uplink carriers within a cell and avoid the interference among frequencies.

At present, there are some resource scheduling methods for LTE network, such as dynamic scheduling (DS), persistent scheduling (PS) and group scheduling (GS).

The dynamic scheduling means to schedule resource dynamically based on the channel condition. In downlink, the eNodeB allocates resource based on the amount of data in buffer, the channel condition etc.. In uplink, an uplink resource request message is sent first when a UE wants to send uplink data. The eNodeB allocates resource based on the received request message via an uplink resource allocation message. Such a scheme has a better resource utilization and may adjust some parameters of MCS (modulation coding scheme) adaptively based on the channel condition. But it needs more bits for the scheduling request and the resource allocation information to achieve the adaptive adjustment, thus resulting in much signaling overhead.

If the dynamic scheduling is adopted for those smaller packets of VoIP traffic, i.e. a request and grant signaling per TTI, the signaling load will be much heavier. The overhead needs to be reduced for reaching a certain VoIP user amount in the LTE system. Hence, two optimized schemes are proposed, i.e. persistent scheduling and group scheduling.

A fully persistent scheduling is similar to the circuit switching allocation for VoIP, i.e. scheduling relatively fixed resource for the voice traffic once for all. This persistent scheduling is advantageous because of the reduced or avoided L1/L2 control signaling and simplicity. However, it has the lowest resource utilization among all scheduling methods, especially the resource unused by UE during silent period and unused HARP (Hybrid Automatic Repeat Request) retransmission resource. Moreover, since the time/frequency allocation is fixed and the MCS and resource selection is fixed during the whole persistent period configured when the call is set up, such a scheduling method lacks flexibility.

The group scheduling is to allocate resource from a set of resource blocks for a group of UEs. The numbers of resource block equals to the products of the numbers of UE and the average activity factor. The advantages of such a scheduling method are improved resource utilization and lower signaling overhead that the dynamic scheduling. However, this method has the following defects:

i) Difficult to manage the radio resource efficiently, especially because the average activity factor is hard to be estimated, which may cause extra voice packet delay (at no resource case) or resource waste (at superfluous resource case).

ii) Lack of flexibility. Multi-rate codec will not be supported efficiently in a group; UE switching between groups or group reconfiguration are rather complex with a large amount of RRC (Radio Resource Control) signaling. The optimal performance is achieved only when the group is full, hence during the initial heating-up period the performance of group scheduling is low.

iii) Requiring different control channel structures, e.g. BITMAP signaling per TTI, from the normal L1/L2 control channel would be required.

Currently, in the LTE network, a voice packet of upper layer is transmitted per 20 ms. The base station assigns 4 transmissions to a UE within 20 ms based on the persistent scheduling method. A general scheme is that, among the 4 transmissions, the first transmission is an initial transmission (the transmission of the voice packet of the whole 20 ms), and the remaining 3 transmissions are used to ensure the retransmission requirement due to the transmission error of the first transmission. Therefore, the unused transmission resource, which is reserved for retransmission, is wasted. For the voice traffic of lower rate, the average retransmission is less than 1 time, thus the reserved resource being wasted at least 2 times per 20 ms.

To make efficient use of the HARQ retransmission resource during the talk-spurt period, there is a need to find a trade-off between improving resource utilization and decreasing signaling overload.

### SUMMARY OF THE INVENTION

To solve the above problem in the prior art, according to a aspect of the present invention, a method for scheduling resource in a packet network is proposed, wherein user equipments communicate therebetween using the resource allocated by network elements, said communication comprises talk-spurt periods during which data packets are transmitted and silent periods during which silence descriptor packets are transmitted, the method comprises: said network element allocates resource for said user equipments for communication; both said user equipment and said network element detect the presence of said silence descriptor packet, and said network element determines the optimized number of resource unit(s) to be allocated to said user equipment during the interval for transmitting said data packet, based on the coding rate of said user equipment, the selected modulation coding scheme and the valid transmission times; the network element starts timing and the user equipment stops using the allocated resource if a silence descriptor packet is detected; when the timing finishes or a request for allocating resource is received from the user equipment before the end of said timing, said network element allocates the determined optimized number of resource unit(s) to said user equipment, and said user equipment begins to use said determined optimized number of resource unit(s); said network element determines the end of the interval for transmitting said data packet by detecting the silence descriptor packet; and when both said user equipment and said network element detect a silence descriptor packet, said user equipment stops using said determined optimized number of resource unit(s), while said network element releases said determined optimized number of resource unit(s).

According to another aspect of the present invention, a network element for exchanging signaling with user equipments is proposed, wherein said user equipments communicate therebetween using the resource allocated by said network element, said communication is based on packet switching and comprises talk-spurt periods during which data packets are transmitted and silent periods during which silence descriptor packets are transmitted, the network element comprises: a detection means for detecting the presence of said data packet or said silence descriptor packet when said user equipments are communicating therebetween; a resource unit determination means for determining the optimized number of resource units to be allocated to said user equipment during the interval for transmitting said data packet, based on the coding rate of said user equipment, the selected modulation coding scheme and the valid transmission times; a resource units allocation means for allocating the determined optimized number of resource units to said user equipment upon the expiration of the timer for the interval for transmitting said silence descriptor packet or the reception of a request for allocating resource from the user equipment before the expiration of said timer; a timer adapted to start timing when said silence descriptor packet is detected to determine the end of said interval for transmitting said silence descriptor packet; and a state transition control means for changing said network element from a talk-spurt state to a silent state when it detects said silence descriptor packet, or changing said network element from the silent state to the talk-spurt state when it detects said data packet.

According to yet another aspect of the present invention, a user equipment is proposed, wherein said user equipment communicates with other user equipments using the resource allocated by network elements, said communication is based on packet switching and comprises talk-spurt periods during which data packets are transmitted and silent periods during which silence descriptor packets are transmitted, the user equipment comprising: a detection means for detecting the presence of said silence descriptor packet or said data packet when said user equipment is communicating; and a state transition control means for changing said user equipment from a talk-spurt state to a silent state when it detects said silence descriptor packet, or changing said user equipment from the silent state to the talk-spurt state when it detects said data packet.

### BRIEF DESCRIPTION OF THE DRAWINGS

These and many other features and advantages of the present invention will become apparent from the following description of the embodiments of the present invention with reference to the drawings, wherein:

FIG. 1 shows the architecture of a LTE network;

FIG. 2 is a flowchart of the method for scheduling resource according to an embodiment of the present invention;

FIG. 3 further illustrates the method for scheduling resource according to the embodiment of the present invention;

FIG. 4 illustrates how the UE is synchronized in state with the eNodeB;

FIG. 5 is a block diagram of the network element according to an embodiment of the present invention;

FIG. 6 is a block diagram of the UE according to an embodiment of the present invention.

### DETAILED DESCRIPTION OF THE INVENTION

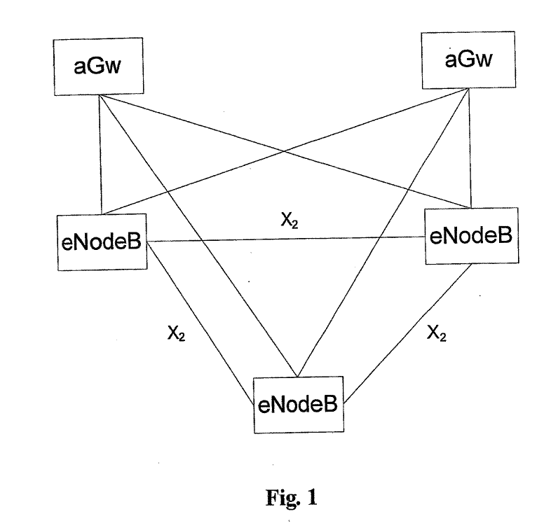

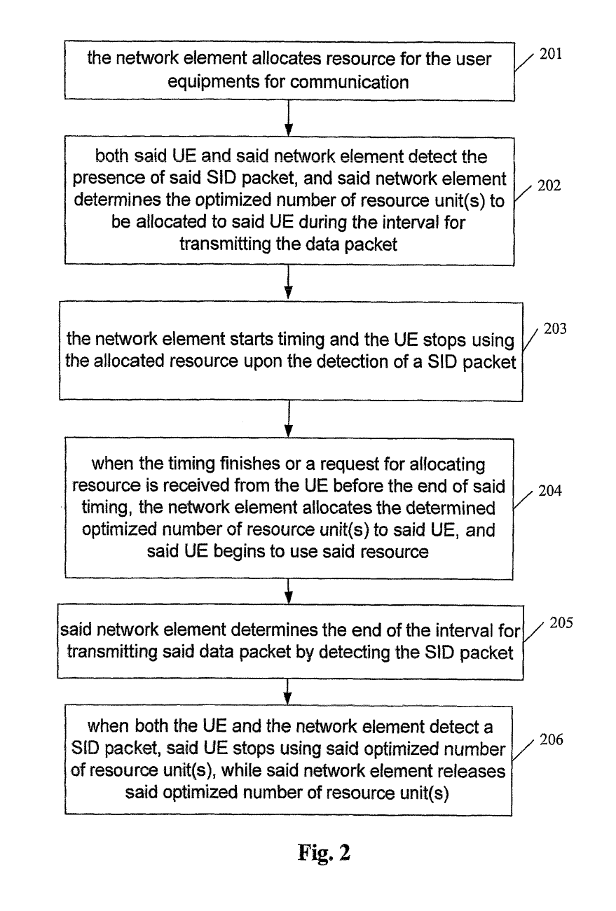

The present invention proposes a method for semi-persistently scheduling resource for data packet using retransmission statistics during the talk-spurt periods in a packet network. With reference to FIG. 2, the method for scheduling resource according to an embodiment of the present invention is described. This method may be applied to the system shown in FIG. 1. The description of the above system will not be repeated herein.

As shown in FIG. 2, firstly, in step 201, the network element allocates resource for the UE for communication. Herein, the network element may be for example the eNodeB shown in FIG. 1. In the present embodiment, any existing and future solution may be adopted for allocating resource, for example, but not exclusively eNodeB allocating resource to UEs by means of the above-mentioned persistent scheduling method.

In step 202, both the user equipment and the eNodeB detect if a SID packet is present, and the eNodeB determines the optimized number of RU(s) to be allocated to the UE during the interval for transmitting the data packet, based on the coding rate of the UE, the selected modulation coding scheme and the valid transmission times. The detection of said data packet may be performed for example by a detection means installed in the eNodeB. It should be noted that since the SID packet and the data packet such as a VoIP packet are encapsulated by RTP (Real-time Transport Protocol), RTP identifies at the corresponding indicator in the header of RTP to distinguish between SID packet and data packet. Furthermore, since the SID packet is relatively small (tens of bits) while the data packet has at least more than 100 bits (256 bits for 12.2 kbps), they could also be distinguished from the size of packet. Therefore, the SID packet and the data packet could be identified at the PDCP packet data convergence sub-layer.

According to a preferred embodiment of the present invention, the determination of the optimized number of RU(s) to be allocated to the UE may be implemented as follows. Firstly, the power control module of the eNodeB controls the transmission power of the UE. Next, the eNodeB pre-estimates a valid SINR (Signal to Interference and Noise Ratio) based on the transmission power of the UE, and then selects a MCS (Modulation Coding Scheme), for example QPSK½, QPSK⅓, QPSK⅔ or QPSK¾ etc. Finally, the eNodeB determines the number of RU(s) to be allocated to the UE, based on the VoIP coding rate of the UE (for example, 12.2 kbps), the modulation coding scheme which is selected by the eNodeB using the signal to interference and noise ratio calculated based on the signals received from the UE and the valid transmission times which is calculated as a function of the UE's historical BLER (Block Error Rate) deduced by the eNodeB using statistics, thus obtaining an optimized number of RUs. For example, assume that the UE's VoIP coding rate is 12.2 kbps, then 40 bytes (or 320 bits) are required to transmit a VoIP voice packet at the physical layer. Assume that the selected modulation coding scheme is QPSK½ corresponding to 144 bits, then in the conventional case, this requires 3 RUs (ceiling (320/144)) for transmitting the whole 320 bits of a VoIP voice packet at a time. Assume that there are 5 HARQ processes, and the TTI is 1 ms, then a HARQ process has 4 times of transmission within 20 ms (20 ms/1 ms/5). If 3 RUs are required, as described above, and 2 times of transmission are successful, that is to say the number of valid transmission is 2, then 12 RUs are required in total (3×4), thus the following 2 times of transmission are wasted, i.e. 6 RUs (3×2). However, such a waste could be avoided by using the method according to the present invention. The optimized number of RUs may be expressed as:

N=the optimized number of RUs=ceiling (ceiling (x/y)/z)

Where x is the number of bits of physical layer corresponding to the VoIP coding rate, which is herein 320 bits, y is the number of bits carried by one RU corresponding to the modulation coding scheme, which is herein 144 bits, and z is the average valid transmission times within 20 ms. Z is also a function of the block error rate, and may be expressed as z=f (BLER). Hence, the above formula is written as N=ceiling (ceiling (320/144)/2)=(3/2)=2. It can be therefore seen that, two RUs are used to transmit while one RU is saved, and with the same valid transmission times 2, 8 RUs are used for the 4 times of transmission in which 2 RUs are wasted. Since the average number of valid transmission (z) is greater than 1, the optimized number of RUs is certainly reduced. In this way, in comparison with those conventional methods, the present method improves the utilization of resource, and therefore the saved resource (12−8=4) may be allocated to other users. Moreover, in a case in which the data delay (buffer area) on the UE increases or the quality of the channel used by the user degrades, the eNodeB may adopt temporarily the dynamic scheduling so as to allocate additional RUs to the UE, which is (are) generally 1 or 2 RU(s), but the eNodeB may decide the number of RU(s) to be added according to practical, situation.

Then, in step 203, the eNodeB starts timing and the user equipment stops using the allocated resource upon the detection of a SID packet. Said timing may be performed for example by a timer installed in the eNodeB. For example, a timing interval of 160 ms may be set for the timer, which may be longer due to the processing time concerned at physical layer, thus the end of the interval for transmitting the SID packet being determined when the timing finishes.

Next, in step 204, when the timing in step 202 finishes or a resource request is received from the UE before the end of said timing, the eNodeB allocates the determined optimized number of RU(s) to the UE, and the UE stops using the allocated resource and begins to use the determined optimized number of resource unit(s). Then, in step 205, the eNodeB determines the end of the interval for transmitting the data packet by detecting the SID packet. Finally, in step 206, once the eNodeB and the UE detect a SID packet, the UE stops using the determined optimized number of resource unit(s), while the eNodeB releases the determined optimized number of RU(s).

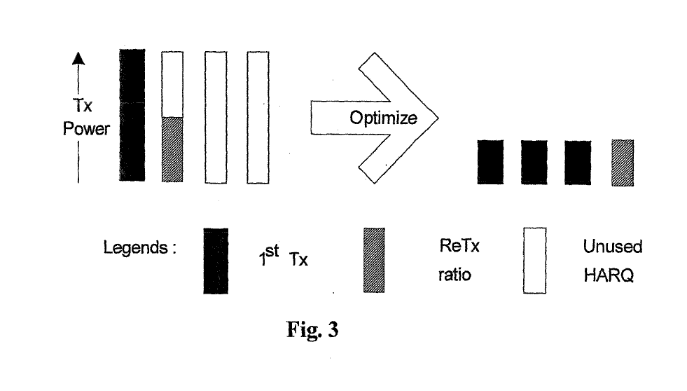

FIG. 3 further illustrates the method for scheduling resource according to the embodiment of the present invention. It can be seen from FIG. 3 that, less than 2 RUs are used among 4 RUs in the conventional case, but with the optimizing method according to the present invention, the reduced RU(s) is(are) utilized substantially while the transmission power required by the UE is economized.

It should be noted that, in the LTE network, the minimal allocation unit that the eNodeB allocates resource to the UE is 1 RU (resource unit), and the allocation unit of transmission power of the UE is RU (known as TxPSD). In the case of the same unit transmission power, the less the number of RUs, the lower the transmission power required by the UE. As such, in the case that the UE's transmission power is limited, the less the number of RUs allocated to the user, the higher the UE's unit transmission power could be, thus a user is able to communicate with a base station at a farther location.

It should be appreciated that, the UE may make use of the allocated resource substantially by employing the method of the present embodiment, via the optimized modulation coding scheme and RUs selection. The reduction of the number of RUs to be allocated to the UE saves the UE's transmission power, while the QoS of the UE at the border of a cell is improved for a power-limited system, thus increasing the coverage of the cell. Moreover, there is no need to increase the grant signaling cost by adopting the persistent scheduling method during the talk-spurt period. There is also no need to add new L1/L2 signaling by detecting automatically the data packet at the eNodeB side. In order to improve flexibility (e.g. supporting adaptive HARQ), the eNodeB can still use dynamic scheduling grant to override the persistent scheduling during the talk-spurt period.

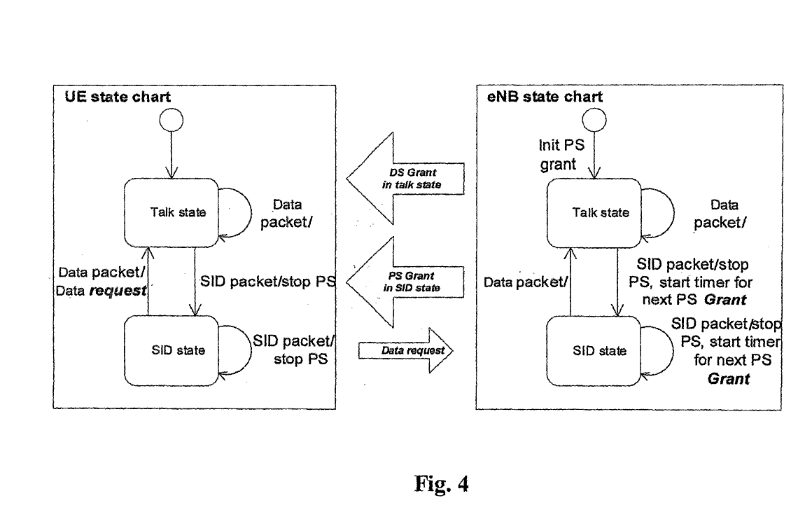

To save signaling cost, the method of the present embodiment synchronizes implicitly the UE and the eNodeB using grant synchronization state, to avoid resource allocation conflict among different UEs. This synchronization scheme makes eNodeB unnecessary to send a signaling to stop the last persistent grant. FIG. 4 illustrates how the UE is synchronized in state with the eNodeB.

It can be seen from FIG. 4 that, each UE has two states. One is talk-spurt state in which the UE is in talk-spurt period, the other is SID state in which the UE is in silence period. A state transition means transition from the state before receiving trigger event to the state after executing actions. The format description of state transition may be for example “Trigger event/Action 1, action 2, and so on after triggering”, such as “SID packet/stop persistent scheduling” which means stopping the last persistent scheduling grant after receiving SID packet. “SID packet/stop persistent scheduling, start timer for next PS grant” means that the eNodeB stops the last persistent scheduling grant after receiving SID packet, then starts a timer to trigger a scheduler of eNodeB to generate a new persistent scheduling grant by the end of 160 ms. “Data packet/data request” means generating a data request after receiving date packet for triggering a scheduler of UE to send a resource request to the eNodeB, and transit its state. It can be seen from the figure that, when a UE in the SID state detects a data packet, the UE sends a resource allocation request to an eNodeB which allocates new resource for the UE immediately upon receiving said request. Moreover, in a case in which the data delay (buffer area) on the UE increases or the quality of the channel used by the user degrades, the eNodeB may adopt temporarily the dynamic scheduling (DS Grant in talk state) so as to allocate additional RU(s) to the UE, which is (are) generally 1 or 2 RU(s), but the eNodeB may decide the number of RU(s) to be added according to practical situation.

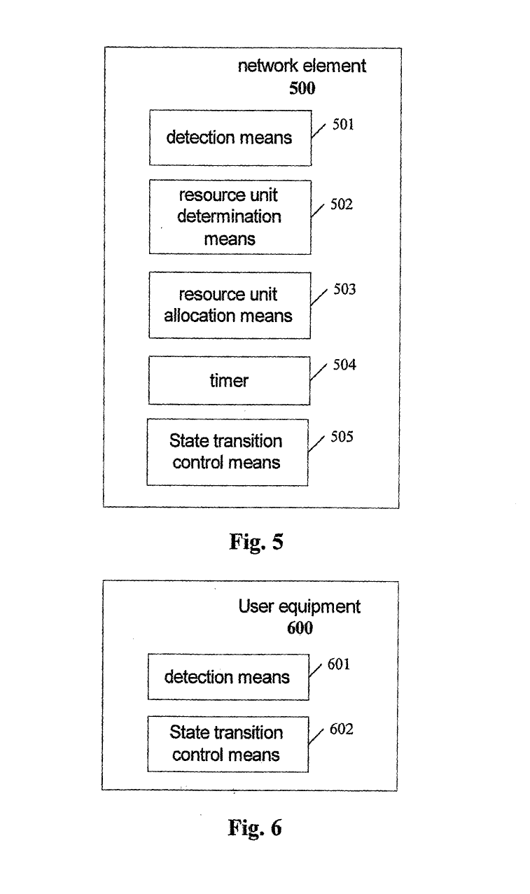

Thereby, the signaling overhead is reduced greatly by synchronizing UE with eNodeB to avoid resource allocation conflict among different UEs. Based on the same inventive concept, according to another aspect of the present invention, a network element is proposed for exchanging signaling with the UEs. The network element will be described in the following with reference to FIG. 5.

FIG. 5 is a block diagram of the network element 500 according to an embodiment of the present invention, which is for example an eNodeB. The network element 500 also includes a detection means 501, a resource unit determination means 502, a resource unit allocation means 503, a timer 504 and a state transition control means 505. When the UEs are communicating with each other, detection means 501 detects the presence of the data packet or SID packet. Meanwhile, said resource unit determination means 502 determines the optimized number of resource units to be allocated to the UE during the interval for transmitting said data packet, based on the coding rate of said UE, the selected modulation coding scheme and the valid transmissions. Upon receiving UE talk request or expiration of the timer for SID interval, the resource unit allocation means 503 allocates the determined optimized number of resource units to said UE. Meanwhile, upon detection of the SID packet, timer 504 starts timing to determine the end of the interval for transmitting the SID packet. In the present embodiment, the timing period of the timer 504 may be set as 160 ms. When the timer 504 starts timing, the network element 500 releases the allocated resource units, and when the timer 504 finishes timing, the network element 500 reallocates new optimized resource to the UE for example by the persistent scheduling method. Referring to FIG. 4 again, the state transition control means 505 is used for transiting the network element from the talk-spurt state to the SID state, and vice versa. The state transition is triggered by the trigger event as shown in FIG. 4. The resource scheduling grant for the UE is stopped when a SID packet is detected by the detection means 501, and the timer 504 starts timing. The network element 500 allocates new optimized resource for the UE, when the timer 504 finishes its timing, or when the UE requests the network element 500 to allocate resource to it before the finish of timing.

In implementation, the network element 500 of this embodiment as well as the detection means 501, the resource unit determination means 502, the resource unit allocation means 503, the timer 504 and the state transition control means 505, may be implemented in software, hardware or a combination of them. For example, those skilled in the art are familiar with a variety of devices which may be used to implement these components, such as micro-processor, micro-controller, ASIC, PLD and/or FPGA etc.. The detection means 501, the resource unit determination means 502, the resource unit allocation means 503, the timer 504 and the state transition control means 505 of the present embodiment may be either implemented as integrated into the network element 500, or implemented separately, and they may also be implemented separately physically but interconnected operatively.

In operation, the network element for exchanging signaling with UEs of the embodiment illustrated in connection with FIG. 5, may improve the resource utilization of the UEs via an optimized modulation coding scheme and RUs selection. The reduction of the RUs to be allocated to the UE saves the UE's transmission power, while the QoS of the UE at the border of a cell is improved for a power-limited system, thus increasing the coverage of the cell. Moreover, there is no need to increase the grant signaling cost by adopting the persistent scheduling method during the talk-spurt period. There is also no need to add new L1/L2 signaling by detecting automatically the data packet at the eNodeB side.

Based on the same inventive concept, according to yet another aspect of the present invention, a user equipment is proposed. The user equipment will be described in the following with reference to FIG. 6.

FIG. 6 is a block diagram of the UE 600 according to an embodiment of the present invention. The UE 600 includes a detection means 601 and a state transition control means 602. The detection means 601 is used for detecting the presence of SID packet or data packet when the UE is communicating. The state transition control means 602 is used for transiting the UE from talk-spurt state to SID state, and vice versa. The state transition is triggered by a trigger event as shown in FIG. 4. When the detection means 601 detects a SID packet, the UE stops using the optimized resource allocated by the network element. When the detection means 601 detects a data packet while the UE is in silent state, the UE sends a request for allocating resource to the network element.

In implementation, the UE 600 of this embodiment as well as the detection means 601 and the state transition control means 602 it includes, may be implemented in software, hardware or a combination of them. For example, those skilled in the art are familiar with a variety of devices which may be used to implement these components, such as micro-processor, micro-controller, ASIC, PLD and/or FPGA etc..

In operation, said UE of the embodiment illustrated in connection with FIG. 6, may improve the resource utilization without increasing signaling cost, by detecting automatically the presence of SID packet or data packet both at UE and at eNodeB, by employing the persistent scheduling and synchronizing the states of UE and eNodeB, and by reallocating the saved resource of UE during the talk-spurt period to other UEs.

Although the exemplary embodiments of the method for scheduling resource and the network element for exchanging signaling with UEs of the present invention are described above in detail, the above embodiments are not exhaustive, and those skilled in the art can make numerous changes and modifications within the spirit and scope of the present invention. Therefore, the present invention is not limited to those embodiments, the scope of which is defined only by the appended claims.

1. A method for scheduling resource in a packet network, wherein user equipments communicate therebetween using the resource allocated by a network element, said communication comprises talk-spurt periods during which data packets are transmitted and silent periods during which silence descriptor packets are transmitted, the method comprising:
said network element allocates resource for said user equipments for communication;
both said user equipment and said network element detect the presence of said silence descriptor packet, and said network element determines the optimized number of resource unit(s) to be allocated to said user equipment during the interval for transmitting said data packet, based on the coding rate of said user equipment, the selected modulation coding scheme and the valid transmission times;
the network element starts timing and the user equipment stops using the allocated resource upon the detection of a silence descriptor packet;
when the timing finishes or a request for allocating resource is received from the user equipment before the end of said timing, said network element allocates the determined optimized number of resource unit(s) to said user equipment, and said user equipment begins to use said determined optimized number of resource unit(s);
said network element determines the end of the interval for transmitting said data packet by detecting the silence descriptor packet; and
when both said user equipment and said network element detect a silence descriptor packet, said user equipment stops using said determined optimized number of resource unit(s), while said network element releases said determined optimized number of resource unit(s).

2. The method according to claim 1, wherein said silence descriptor packet is transmitted once per 160 ms during said silent period, and said data packet is transmitted once per 20 ms during said talk-spurt period.

3. The method according to claim 1, wherein if there is no delay, then the period of said timing is set as 160 ms.

4. The method according to claim 1, wherein said modulation coding scheme is selected by said network element using the signal to interference and noise ratio calculated based on the signals received form said user equipment.

5. The method according to claim 1, wherein said modulation coding scheme comprises QPSK½, QPSK ⅓, QPSK ⅔, and QPSK ¾.

6. The method according to claim 1, wherein said valid transmission times is calculated as a function of the user equipment's historical block error rate deduced by said network element using statistics.

7. The method according to claim 1, wherein said network element allocates additional resource to the user equipment in the case of delay.

8. A network element for exchanging signaling with user equipments, wherein said user equipments communicate therebetween using the resource allocated by the network element, said communication is based on packet switching and comprises talk-spurt periods during which data packets are transmitted and silent periods during which silence descriptor packets are transmitted, the network element comprising:
detection means for detecting the presence of said data packet or said silence descriptor packet when said user equipments are communicating therebetween;
resource unit determination means for determining the optimized number of resource unit(s) to be allocated to said user equipment during the interval for transmitting said data packet, based on the coding rate of said user equipment, the selected modulation coding scheme and the valid transmission times;
resource unit(s) allocation means for allocating the determined optimized number of resource unit(s) to said user equipment upon the expiration of the timer for the interval for transmitting said silence descriptor packet or the reception of a request for allocating resource from the user equipment before the expiration of said timer;
timer adapted to start timing when said silence descriptor packet is detected to determine the end of said interval for transmitting said silence descriptor packet; and
state transition control means for changing said network element from a talk-spurt state to a silent state when it detects said silence descriptor packet, or changing said network element from the silent state to the talk-spurt state when it detects said data packet.

9. The network element according to claim 8, wherein said silence descriptor packet is transmitted once per 160 ms during said silent period, and said data packet is transmitted once per 20 ms during said talk-spurt period.

10. The network element according to claim 8, wherein when said network element changes from said talk-spurt state to said silent state, it stops the resource scheduling grant for said user equipment, and said timer start timing; and when said network element changes from said silent state to said talk-spurt state, it allocates new optimized number of resource unit(s) for said user equipment.

11. The network element according to claim 8, wherein the period of said timing is 160 ms if there is no delay.

12. The network element according to claim 8, wherein said modulation coding scheme is selected by said network element using the signal to interference and noise ratio calculated based on the signals received form said user equipment.

13. The network element according to claim 8, wherein said modulation coding scheme comprises QPSK½, QPSK ⅓, QPSK ⅔, and QPSK ¾.

14. The network element according to claim 8, wherein said valid transmission times is calculated as a function of the user equipment's historical block error rate deduced by said network element using statistics.

15. The network element according to claim 8, wherein said network element allocates additional resource to the user equipment in the case of delay.

16. A user equipment, wherein said user equipment communicates with other user equipments using the resource allocated by network elements, said communication is based on packet switching and comprises talk-spurt periods during which data packets are transmitted and silent periods during which silence descriptor packets are transmitted, the user equipment comprising:
detection means for detecting the presence of said silence descriptor packet or said data packet when said user equipment is communicating;
state transition control means for changing said user equipment from a talk-spurt state to a silent state when it detects said silence descriptor packet, or changing said user equipment from the silent state to the talk-spurt state when it detects said data packet.

17. The user equipment according to claim 16, wherein said silence descriptor packet is transmitted once per 160 ms during said silent period, and said data packet is transmitted once per 20 ms during said talk-spurt period.

18. The user equipment according to claim 16, wherein when said user equipment changes from said talk-spurt state to said silent state, it stops using the optimized number of resource unit(s) allocated by said network element, and when said user equipment changes from said silent state to said talk-spurt state, it sends a request for allocating resource to said network element
